(19) United States
(12) Patent Application Publication
(10) Pub. No.: US 2010/0317481 A1
(43) Pub. Date: Dec. 16, 2010

(54) All Gear Crossed-Axis Differential

(76) Inventors: Keith E. Gleasman, Fairport, NY (US); James Y. Gleasman, Rochester, NY (US)

Correspondence Address: Woods Oviatt Gilman LLP, 700 Crossroads Bldg, 2 State St., Rochester, NY, 14614, US

(21) Appl. No.: 12/482,185

(22) Filed: Jun. 10, 2009

(51) Int. Cl. F16H 48/06

(52) U.S. Cl. 475/226

(57) ABSTRACT

An all-gear differential designed primarily for motor vehicle use, employing a “cross-axis” arrangement defined by a pair of helical “side” or “S” gears rotatable about a common first axis and mountable on respective opposite vehicle axles, and one or more pairs of “balance” or “B” gears rotatable about second axes orthogonal to the first axis. The B gears have helical central portions for meshing with the helical S gears, and have spur gear end portions for meshing with each other. The B/S helical gear tooth ratio between each balance gear and its respective side gear greater than 0.60 and preferably is about 0.75, and the B/S helical angle ratio between each balance gear and its respective side gear is less than 43°/47°, more preferably is less than 40°/50° and about 35°/55°, and most preferably is about 27°/63°.

### TECHNICAL FIELD

The present invention relates to an all-gear differential designed primarily for a motor vehicle for providing limiting slip of the vehicle's drive wheels; more particularly, to such differentials employing a “crossed-axis” arrangement defined by a pair of helical “side” gears, referred to herein as “S” gears, for receiving the axle shafts of the drive wheels and rotatable about a common first axis, and one or more pairs of “balance” gears, referred to herein as “B” gears, attached to a carrier housing, each balance gear rotatable about a second axis orthogonal to the first axis, and having helical central portions for meshing with the helical side gears, and having spur gear end portions for meshing with each other, whereby each balance gear receives engine torque by its attachment to the carrier housing; and most particularly, to crossed-axis differential arrangements that address internal gear ratio relationships wherein the B/S helical gear tooth ratio between the central portion of each balance gear and its respective side gear is greater than 0.60 and preferably is about 0.75 and the B/S helical angle ratio between the central portion of each balance gear and its respective side gear is less than 43°/47°, more preferably is less than 40°/50° and about 35°/55°; and most preferably is about 27°/63°.

### BACKGROUND OF THE INVENTION

While there are many types of limited-slip differentials, some of the most commercially successful have been the all-gear differentials based upon the designs of Vernon E. Gleasman, and the most efficient of these have been those based upon his “crossed-axis” design that has been identified commercially, for example, as the Torsen®-Type 1 differential. As used herein, the term “helical” in reference to a type of gear should be construed in its broadest sense, and is intended to include all types of helical gears used in the differential art including, but not limited to modified or hybrid helical gears. As used herein, the term “crossed-axis” means a differential gear set having a pair of helical “side” gears (worms), rotatable about a common first axis, and one or more pairs of balance gears, each rotatable about a second axis orthogonal to the first axis, and having helical central portions (worm-wheels) for meshing with the helical side gears, and having spur gear end portions for meshing with each other. A recent improvement of such known differentials using crossed-axis planetary gearing is disclosed in U.S. Pat. No. 6,783,476 (“Compact Full-Traction Differential”, assigned to the same assignee, Torvec, Inc., as the present invention and identified by the trademark “IsoTorque”), incorporated by reference herein. The improved differential disclosed in the just-identified patent is smaller in both size and weight than earlier designs of other prior art crossed-axis differentials, and it is less costly to manufacture, while meeting similar load-carrying specifications.

All traditional crossed-axis differentials include pairs of “balance” (combination worm-wheel and spur) gears, e.g., 131,132 and 131a,132a in FIGS. 1a and 1b, that mesh with each other through spur-gear portions 133 formed at each end and also mesh with the side-gear helical worm 141,142 through helical teeth formed in worm-wheel portions 134.

In conventional worm-drive gearing used outside the differential arts, the “worm” S is a cylindrical gear with teeth in the form of a helix that mates with a larger gear, typically a spur gear, generally identified as a worm gear or “worm-wheel”. Typically, the worm and worm-wheel rotate about respective axes contained in respective orthogonal planes, hence the term “crossed axis”. In conventional worm-drive gearing, the worm S has a relatively high helix angle and is much smaller in diameter than the mating worm gear. Thus, there is a mechanical advantage as energy is transferred from the smaller diameter worm S to the larger diameter worm-wheel B and a concomitant mechanical disadvantage when energy is transferred from the larger diameter worm-wheel B to the smaller diameter worm S, generally preventing significant back-drive of the worm-wheel. When the worm, worm-wheel gear set is used in a differential, this general relationship makes it more difficult for B to turn S, thereby creating a torque bias between the two opposite operating directions, while also facilitating differentiation when the worm S is driving the worm-wheel B.

When used in a differential, the teeth of S and B need not be formed with conventional worm/worm-wheel teeth as described above for worm-gear driving used outside the differential arts. Instead of the worm being formed as a helical gear and the worm wheel a spur gear, in a differential, “full-helical gearing” can be used. That is, both the worm and the worm wheel can be formed as helical gear teeth or, as Torvec, Inc. has done more recently, as a unique “hybrid” design incorporating a combination of standard gear design elements from both helical gearing and worm/worm-wheel gearing.

There are relatively few, if any, crossed-axis full-helical gearing arrangements outside of these limited-slip differential applications. Therefore, crossed-axis full-helical gearing can be regarded as unique to the differential arts and therefore is quite esoteric. Thus, general crossed-axis gear technology provides little expertise or prior art that is of help on the design of crossed-axis gearing arrangements for limited-slip differentials.

For example, a conventional worm S used in general crossed-axis technology typically is much smaller in diameter than the mating worm-wheel B. On the other hand, in prior art differential applications, side-gear worm S is larger in diameter than worm-wheel B. In a most common prior art crossed-axis full helical gear differential, the side-gear worm S has 13 teeth while the mating worm-wheel B has 7 teeth resulting in a B/S helical gear tooth ratio of 0.54. Despite having the packaging latitude within the differential member itself to do so, prior art differential gear tooth ratios never exceeded 0.60 with accepted design trending toward increasing the diameter of the side-gear worm S relative to the diameter of worm-wheel B rather than decreasing it.

As another example, in general cross-axis technology, the worm S has a relatively high helix angle. On the other hand, in prior art crossed-axis differentials, it is preferred that the transfer of torque be facilitated near equally in both directions and, therefore, most crossed-axis designs use near unity (43°/47°) helix angles in the S and B gears.

In order to understand the significance of these differential gearing attributes, it is helpful to understand how an all-gear crossed-axis differential produces limited slip. In vehicles equipped with conventional non-crossed-axis differentials (i.e., differentials commonly referred to as “open” differentials), when one drive wheel of the vehicle loses traction, most of the engine torque is immediately delivered to the slipping wheel. However, with crossed-axis differentials, the mechanical disadvantage created by the B-to-S gear connection from the engine to the wheel constrains the excess slipping of the low-traction wheel. The maximum torque ratio which is supported by a particular differential design is termed the “bias ratio”, expressed as the quotient of the torque in the higher-torque axle to the torque in the lower-torque axle. For example, a 4:1 bias ratio means that the crossed-axis differential is capable of delivering, to the drive wheel having better traction, four times the amount of torque which can be supported by the lower traction wheel. This same connection, when operating in the S-to-B direction, enhances the response of the differential to the changes in drive wheel speeds when the vehicle is turning corners and the outside wheels are traveling over a longer distance than the inside wheels within the same time period. Thus, a relatively high differential bias ratio is desirable, for both these reasons.

For IsoTorque crossed-axis designs, this worm/worm-wheel relationship is considered important to the torque-bias between the drive wheels and contributes to easy differentiation of the drive wheels under all driving conditions. Therefore, IsoTorque designs all use B/S helix-angle ratios equal to or greater than 40°/50°.

Contrarily, although the manufacturers of prior art crossed-axis differentials, including the manufacturers of the Torsen Type 1 differentials, have acknowledged that the helical gearing of the B/S combinations contributes to the torque-bias, they attribute this contribution to the increased friction produced by the sliding and end thrust forces that accompany helical gearing. Little consideration is given to the effect of helical gearing itself in relation to the facilitation of differentiation. (See, for example, the technical paper, “The development of a differential for the improvement of traction control”, by S. E. Chocholek, C368/88, IMechE, 1988.) Therefore, the present commercially available crossed-axis differentials of the prior art typically use near unity in the B/S helix-angle ratio, e.g., 43°/47° (in orthogonal cross-axis helical gearing, the helical angles must always total 90°).

What is needed in the art is a crossed-axis differential having substantially improved torque bias and differential bias characteristics.

What is needed in the art is a crossed-axis differential wherein the B/S tooth ratio is greater than 0.6 and the helix angle ratio is less than 43°/47°.

It is a principal object of the invention to provide an improved crossed-axis differential that provides an increased torque bias of 7.0 or higher.

It is a principal object of the invention to provide an improved crossed-axis differential that provides an increased torque bias while substantially reducing the differential's effort to differentiate.

### SUMMARY OF THE INVENTION

Briefly described, the present invention relates to all-gear differentials designed primarily for motor vehicle use for limiting slip of the vehicle's drive wheels wherein such differentials employ a “crossed-axis” arrangement defined by a pair of helical “side” or “S” gears rotatable about a common first axis and mountable on respective opposite vehicle axles, and one or more pairs of “balance” or “B” gears rotatable about second axes orthogonal to the first axis and mountable to a carrier housing that is drivable by the vehicle's engine. The B gears have helical central portions for meshing with the helical S gears, and have spur gear end portions for meshing with each other. The B/S helical gear tooth ratio between each balance gear and its respective side gear is greater than 0.60, preferably as high as 0.75, and the B/S helical angle ratio between each balance gear and its respective side gear is less than 43°/47°, more preferably is less than 40°/50° and about 35°/55° and most preferably is about 27°/63°.

While driving a vehicle around a corner, the outside wheel must rotate faster than the inside wheel in order to maintain traction on the road. With traditional traction-aiding differentials using, for example, friction clutches, this can occur only if the torque bias ratio is exceeded (the device creating the bias ratio binds the two halves of the split axle) forcing the majority of torque to the slower-moving inside wheel, dictated by the magnitude of the torque bias ratio.

A crossed-axis differential in accordance with the present invention, however, is a two-way torque-transmitting device due to its novel helix angles and tooth ratios. The effort to differentiate does not come from the engine as believed in some prior art or as espoused in the aforementioned technical paper by Chocholek, but rather from the tractive effort between the road surface and the tires of the vehicle. The vehicle's changing momentum places a force on the tires, forcing them to differentiate from the road surface. Working in this direction, the side gear has a mechanical advantage to turn over the balance gears due to the novel helix angle, rather than the balance gears disadvantage to turning over the side gears from the engine side. This directionality means that the improved differential does not have to overcome its high bias ratio in order to differentiate while cornering. Thus, even with high input loads from the engine, a driver is able to use more throttle through corners with less chance of individual wheel spin or interference with differentiation thereby improving the handling and safety features of the vehicle because of the sustained traction.

### BRIEF DESCRIPTION OF THE DRAWINGS

The present invention will now be described, by way of example, with reference to the accompanying drawings, in which:

FIG. 1a is a schematic and partially cross sectional view of a crossed-axis differential in accordance with the present invention having two sets of combination gears of the type being improved herein;

FIG. 1b is a schematic and partially cross sectional view of the differential of FIG. 1a, the view in FIG. 1b being taken in the plane 1B-1B of FIG. 1a;

FIG. 2a is a schematic and partially cross sectional view of a crossed-axis differential in accordance with the present invention having three sets of combination gears of the type being improved herein;

FIG. 2b is a schematic and partially cross sectional view of the differential of FIG. 2a, the view in FIG. 2b being taken in the plane 2B-2B of FIG. 2a; and

FIG. 3 is a chart showing improvements in mechanical advantage using various B/S ratios in accordance with the invention.

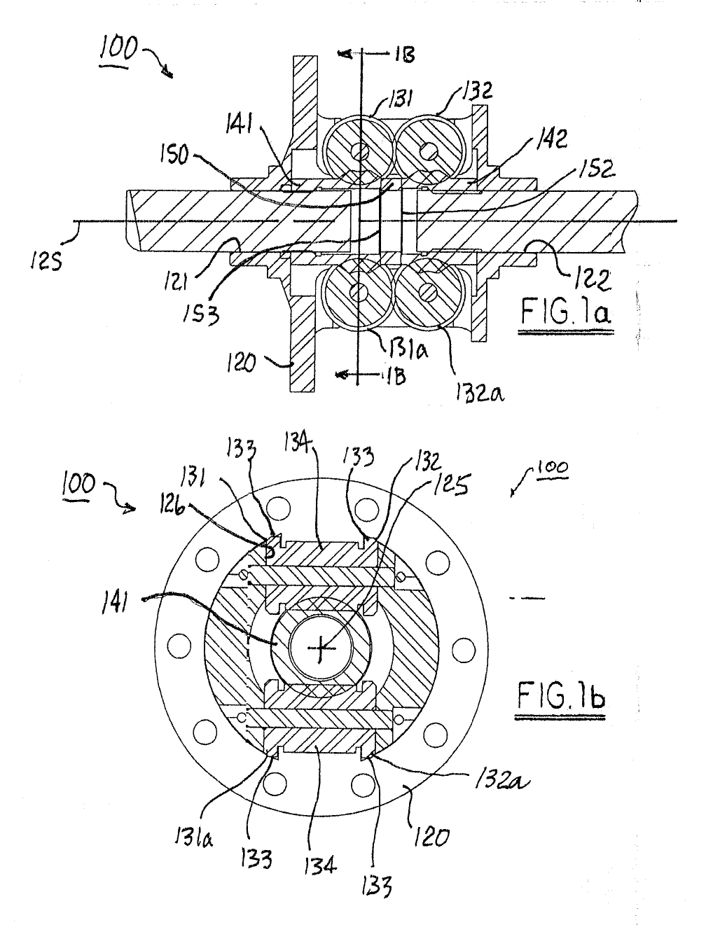

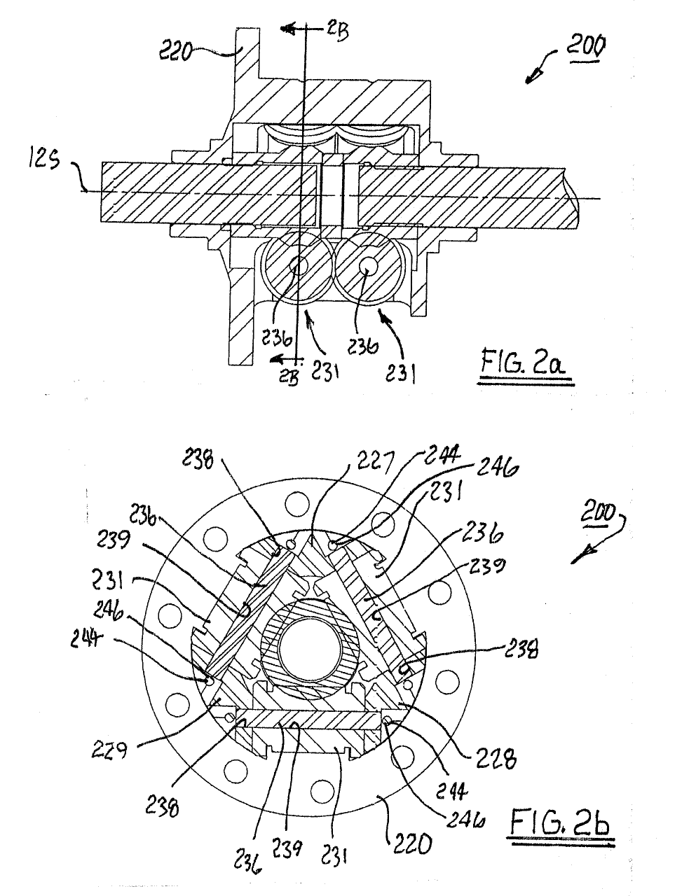

Note: The crossed-axis differential features shown in FIGS. 1-2 are outwardly similar to those of prior art differentials. However, the differential invention illustrated by exemplary FIGS. 1-2 embody the novel gear-tooth ratios and novel helical-angle ratios of the present invention and therefore should not be interpreted as prior art.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

The invention herein improves on the prior art compact full-traction differential disclosed in U.S. Pat. No. 6,783,476 referenced above and has a basic format similar to that prior art differential. Therefore, reference is first made to FIGS. 1a and 1b that show two views of a complete cross-axis gear complex using only two sets of balance gears in accordance with a first exemplary embodiment of a differential 100 in accordance with the present invention.

A housing 120 is preferably made of formed or cast metal and has only three openings, namely, a first set of appropriate openings 121, 122 aligned along a first axis 125 for receiving the respective inner ends of output axles (not shown), and only a single further opening 126, which is rectangular in shape and extends directly through housing 120, and is centered perpendicular to axis 125, creating two openings also known in the art as “windows” for receiving pairs of combination gears.

Two pairs of combination or balance gears 131, 132 and 131a, 132a each have respective spur-gear portions 133 separated by a helix gear portion 134. The respective spur-gear portions 133 of each pair are in mesh with each other, and all of these balance gears. The respective helix gear portions 134 of balance gear pair 131, 132 are in mesh with respective ones of a pair of side-gear helix gears 141,142, while the respective helix gear portions 134 of balance gear pair 131a, 132a are similarly in mesh with, respectively, the same pair of side-gear helix gears 141, 142.

Positioned intermediate the inner ends of side-gear helix gears 141, 142 is a thrust washer 150 that includes respective bearing surfaces 152, 153. Therefore, and referring now specifically to FIG. 1a, when driving torque applied to side-gear helix gears 141, 142 results in thrust to the left, helix gear 142 moves against bearing surface 152 of thrust washer 150, which pushes bearing surface 153 into helix gear 141, which moves against housing 120 (or against appropriate washers positioned conventionally between helix gear 141 and housing 120). Similarly, when driving torque applied to side-gear helix gears 141, 142 results in thrust to the right, helix gear 141 moves against bearing surface 153 of thrust washer 150, which moves into helix gear 142, which moves against housing 120 (or, again, against appropriate washers positioned conventionally between helix gear 142 and housing 120).

FIGS. 2a and 2b show a three-gear set embodiment 200 of another differential according to the present invention, FIG. 2a being taken perpendicular to axis 125. As persons skilled in the art will understand, such three-gear set differentials may be used to carry the exceptional torque requirements of high performance vehicles. This embodiment includes three pairs of balance gear. A housing 220 comprises three opposed mounting sections 227, 228, 229, each mounting section being shaped as a segment with two interior surfaces forming mounting surfaces meeting at 120° and each including a mounting through hole 238. For providing rotatable support for each balance gear 231, a plurality of journal pins 236 are matingly received respectively in the journal holes 239 formed through each balance gear 231 and each respective journal pin 236 is, in turn, received in a respective set of aligned through holes 238 formed in the opposed mounting surfaces of a respective pair of mounting sections 227, 228, 229 of housing 220.

A plurality of stop pins 244 can preferably be used to prevent accidental removal of any respective journal pin 236. Respective stop pins 244 are press-fitted into respective appropriately sized stop pin holes 246 formed in respective mounting sections 227, 228, 229 perpendicular to each respective through hole 238.

While analyzing this design in accordance with the invention, the inventors came to realize that there has been a total lack of recognition of a further mechanical advantage of worm/worm-wheel gearing that occurs only during dynamic operation: namely, by making a reduction of the tooth count of the side gear S in relationship to the tooth count of the mating balance gear B. That is, using, as an example, a well known prior art crossed-axis differential having a tooth count relationship of side gear S=13 teeth and balance gear B=7 teeth, by changing the tooth count relationship to S=9 teeth and B=6 teeth, it results in a B/S tooth count ratio increase from 0.54 to 0.66 and a mechanical advantage increase of 22%. Thus, in accordance with the invention, the inventors recognized that, to improve the dynamic torque bias ratio, the B/S tooth ratio should be made as large as possible, within the constraints of the differential housing and vehicle space allowance. This further mechanical advantage resulting from the large-as-possible B/S tooth ratio, in accordance with the invention, has been totally overlooked by those skilled in the art from the inception of the crossed-axis differential (approximately for 50 years).

Such a higher B/S tooth ratio makes it even more difficult for worm-wheel B to overpower worm S and thereby interfere with differentiation. This arrangement supplements the higher helix angle of S, making it even more difficult for B to rotate S. Thus, during dynamic operation, the higher B/S tooth ratio provides an even greater mechanical advantage in favor of the worm S so that dynamic torque-bias and static torque-bias remain closer, preventing a sudden dramatic drop in torque-bias during differentiation.

While existing packaging parameters would have permitted increasing the B/S tooth ratios in accordance with the invention, the invention's more-favorable gear-tooth ratio has been ignored in prior art crossed-axis differentials because of the generally accepted belief that torque bias is influenced only by helix angle and the friction that accompanies helical gearing. Thus, prior art designs always limited the B/S ratio, resulting in B being considerably smaller in diameter than S and having a much lower tooth count than S. For example, the B/S gear-tooth ratio in prior art Torsen-type differentials has always ranged less than 0.60 (e.g., a well known prior art B/S tooth ratio is 0.54).

The present invention utilizes this heretofore overlooked mechanical advantage of traditional crossed-axis differential gearing. While maintaining the high torque-bias of the IsoTorque limited-slip differential (usually 5:1 or greater), crossed-axis differentials in accordance with the present invention also incorporate B/S gearing that also maximizes the B/S tooth ratio to provide the gearing with a significant additional increase in dynamic mechanical advantage. This improvement increases the differential's effectiveness by augmenting differentiation when operating under high engine torque.

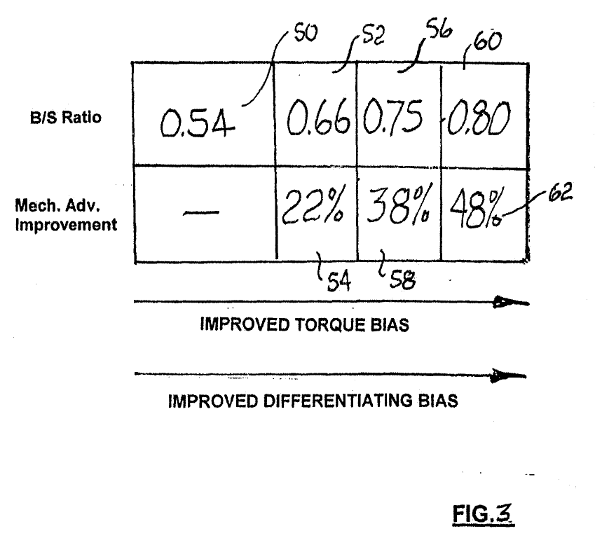

While a crossed-axis differential in accordance with the present invention still requires that S have a larger tooth count than B because of the size of the housing the gears must fit into, such an improved differential intentionally modifies the traditional or prior art B/S relationship to maximize the B/S gear-tooth ratio to be approximately greater than 0.60. Referring to FIG. 3, a prior art resulting B/S gear-tooth ratio 50 of 0.54, wherein the central portion B of the balance gear has 7 teeth and the side gear S has 13 teeth is listed in the first column. Note that by increasing the B/S gear-tooth ratio 52 to 0.66, the dynamic mechanical advantage 54 of the improved gear set increases by 22%. Similarly, by increasing the B/S gear-tooth ratio 56 to 0.75, the dynamic mechanical advantage 58 of the improved gear set increases by 38%; and by increasing the B/S gear-tooth ratio 60 to 0.80, the dynamic mechanical advantage 62 of the improved gear set increases by 48%.

Further, this significant increase in mechanical advantage is supplemental to a higher helix-angle mechanical advantage for crossed-axis differentials in accordance with the present invention. The B/S helical angle ratio is less than 43°/47°, more preferably is less than 40°/50° and about 35°/55°, and most preferably is about 27°/63°. This combination of low B/S helix angle ratio and high B/S gear tooth ratio provides a crossed-axis differential having a torque-bias ratio approaching 10:1 that differentiates even more easily in tight turns under high engine power than that of the currently available crossed-axis differential having a torque bias of 5:1.

While the invention has been described by reference various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. In a crossed-axis differential that transfers rotational forces from an external power source via a plurality of helical balance gears to a pair of helical side gears, the improvement comprising a ratio of the number of helical teeth in each balance gear to the number of helical teeth in each side gear being greater than 0.60.

2. A crossed-axis differential in accordance with claim 1 wherein a ratio of the helical angle of the balance gear teeth to the helical angle of the side gear teeth is less than 43°/47°.

3. A crossed-axis differential in accordance with claim 2 wherein the ratio of the helical angle of the balance gear teeth to the helical angle of the side gear teeth is less than about 40°/50°.

4. A crossed-axis differential in accordance with claim 2 wherein the ratio of the helical angle of the balance gear teeth to the helical angle of the side gear teeth is about 35°/55°.

5. A crossed-axis differential in accordance with claim 2 wherein the ratio of the helical angle of the balance gear teeth to the helical angle of the side gear teeth is about 27°/63°.

6. A crossed-axis differential in accordance with claim 1 wherein said gear teeth ratio is about 0.75.

7. A motor vehicle comprising a crossed-axis differential, wherein a ratio of the number of helical teeth in each balance gear to the number of helical teeth in each side gear is greater than 0.60.

8. A motor vehicle in accordance with claim 7, wherein the ratio of the number of helical teeth in each balance gear to the number of helical teeth in each side gear is about 0.75.

9. A motor vehicle in accordance with claim 7, wherein a ratio of the helical angle of said balance gear teeth to the helical angle of said side gear teeth is less than 43°/47°.

10. A motor vehicle in accordance with claim 7, wherein the ratio of the helical angle of said balance gear teeth to the helical angle of said side gear teeth is about 35°/55°.

11. A motor vehicle in accordance with claim 7, wherein the ratio of the helical angle of said balance gear teeth to the helical angle of said side gear teeth is about 27°/63°.
